(19) United States
(12) Patent Application Publication
(10) Pub. No.: US 2002/0054463 A1
(43) Pub. Date: May 9, 2002

(54) Spin-valve magneto-resistive element, magnetic head and magnetic storage apparatus

(75) Inventors: Naoki Mukoyama, Kawasaki (JP); Kenji Noma, Kawasaki (JP); Jongill Hong, Kawasaki (JP); Junichi Kane, Kawasaki (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU LIMITED

(21) Appl. No.: 09/808,823

(22) Filed: Mar. 15, 2001

(30) Foreign Application Priority Data
Nov. 6, 2000 (JP) 2000-338059

(51) Int. Cl. G11B 5/39

(52) U.S. Cl. 360/324.11; 360/324.12

(57) ABSTRACT

A spin-valve magneto-resistive element is provided with a free magnetic layer having a first surface and a second surface opposite to the first surface, a first stacked structure including a first nonmagnetic metal layer, a first pinned magnetic layer and a first antiferromagnetic layer which are successively stacked on the first surface of the free magnetic layer, and a second stacked structure including a second nonmagnetic metal layer, a second pinned magnetic layer and a second antiferromagnetic layer which are successively stacked on the second surface of the free magnetic layer. A direction of an exchange coupled field between the first pinned magnetic layer and the free magnetic layer and a direction of an exchange coupled field between the second pinned magnetic layer and the free magnetic layer are antiparallel.

### BACKGROUND OF THE INVENTION

This application claims the benefit of a Japanese Patent Application No. 2000-338059 filed Nov. 6, 2000, in the Japanese Patent Office, the disclosure of which is hereby incorporated by reference.

1. Field of the Invention

The present invention generally relates to spin-valve magneto-resistive elements, magnetic heads and magnetic storage apparatuses, and more particularly to a spin-valve magneto-resistive element which is suited for reproducing information magnetically recorded on a magnetic recording medium such as a magnetic disk, a magnetic head which uses such a spin-valve magneto-resistive element, and a magnetic storage apparatus such as a magnetic disk unit which uses such a magnetic head.

Recently, storage capacities of magnetic disk units have increased considerably, and the magnetic disk units are often used as external storage units of computers. There are demands to realize highly sensitive magnetic heads for use in such magnetic disk units.

2. Description of the Related Art

As magnetic heads which satisfy the above described demands, there is a known magnetic head using a spin-valve magneto-resistive (SVMR) element which can obtain a high output independently of a speed of a magnetic recording medium. On the other hand, there is a so-called dual type SVMR element which amplifies the magneto-resistive effect by first and second pinned magnetic layers on respective sides of a free magnetic layer, where each of the first and second pinned magnetic layers has a fixed magnetization direction by provision of an antiferromagnetic layer. The dual type SVMR element has a structure which is basically a combination of two single type SVMR elements. Hence, the dual type SVMR element can amplify magneto-resistive change, and form a highly sensitive reproducing magnetic head.

FIG. 1 is a cross sectional view showing a conventional dual type SVMR element 100. The dual type SVMR element 100 has a free magnetic layer 104, a first stacked structure provided above the free magnetic layer 104, and a second stacked structure provided under the free magnetic layer 104. The first stacked structure includes a nonmagnetic metal layer 103, a pinned magnetic layer 102, and an antiferromagnetic layer 101 which are sequentially stacked above the free magnetic layer 104 in an upward direction. The second stacked structure includes a nonmagnetic metal layer 105, a pinned magnetic layer 106, and an antiferromagnetic layer 107 which are sequentially stacked under the free magnetic layer 104 in a downward direction.

FIG. 2 is a cross sectional view showing a conventional dual type SVMR element 200 which is formed by use of multi-layered ferrimagnetic type pinned magnetic layers 202 and 206. In FIG. 2, those parts which are the same as those corresponding parts in FIG. 1 are designated by the same reference numerals, and a description thereof will be omitted. The multi-layered ferrimagnetic structure of the pinned magnetic layer 202 is formed by a magnetic layer 205, an antiparallel coupling layer 204 made of Ru or the like, and a magnetic layer 203. Similarly, the multi-layered ferrimagnetic structure of the pinned magnetic layer 206 is formed by a magnetic layer 207, an antiparallel coupling layer 208 made of Ru or the like, and a magnetic layer 209.

In the SVMR element, an exchange coupling field is generated between the free magnetic layer and the pinned magnetic layer based on a ferromagnetic coupling. This exchange coupling field causes the magnetization direction of the free magnetic layer to become the same as, that is, to assume a parallel state with respect to, the magnetization direction of the pinned magnetic layer. But because it is preferable to maintain the magnetization direction of the free magnetic layer and the magnetization direction of the pinned magnetic layer approximately 90 degrees to each other in order to reproduce the magnetically recorded information from the magnetic recording medium, it is necessary to suppress the exchange coupling field as much as possible.

However, in the SVMR element, the magnetization direction of the pinned magnetic layer must be fixed to a predetermined direction, and it is thus difficult to suppress the ferromagnetic coupling which acts on the free magnetic layer from this pinned magnetic layer. Accordingly, in the magnetic head which uses the SVMR element in which the magnetization direction of the free magnetic layer is inclined towards the magnetization direction of the pinned magnetic layer, a deterioration of reproduced output of the magnetic head and a deterioration (increased asymmetry) of the head bias are induced thereby.

In addition, compared to a pinned magnetic layer having a single-layer structure, the exchange coupling field generated by the pinned magnetic layer having the multi-layered ferrimagnetic structure with respect to the free magnetic layer is reduced. But it is difficult to fabricate the pinned magnetic layer so as not to generate the exchange coupling field from the pinned magnetic layer with respect to the free magnetic layer.

FIG. 3 is a diagram for explaining effects of an exchange coupling field between a pinned magnetic layer and a free magnetic layer, with respect to an SVMR element. In FIG. 3, the abscissa indicates an exchange coupling field Hin (Oe), the left ordinate indicates a head output (μV/μm) when the SVMR element is used for a magnetic head, and the right ordinate indicates an asymmetry (%) of a reproduced signal waveform when the SVMR element is used for the magnetic head. As may be seen from FIG. 3, the head output decreases and the symmetry of the reproduced signal waveform is lost as the exchange coupling field Hin increases. When an absolute value of the exchange coupling field Hin is 15 Oe or larger, the head output decreases by 10% or more. Hence, it is considered desirable that the SVMR element is able to suppress the exchange coupling field Hin which is generated between the free magnetic layer and the pinned magnetic layer to within a range of −15 Oe to 15 Oe.

However, in the dual type SVMR elements shown in FIGS. 1 and 2, two pinned magnetic layers are provided, one on each side of the free magnetic layer, in order to make the SVMR element highly sensitive. For this reason, compared to the exchange coupling field Hin which is generated with respect to the free magnetic layer in the single type SVMR element, the exchange coupling field generated in the dual type SVMR element is approximately doubled. In other words, exchange coupling fields H1-in and H2-in are generated in each of the dual type SVMR elements shown in FIGS. 1 and 2. As a result, there was a problem in that the deterioration of the head output and the deterioration of the symmetry of the reproduced signal waveform both become particularly notable in the case of the dual type SVMR element.

### SUMMARY OF THE INVENTION

Accordingly, it is a general object of the present invention to provide a novel and useful spin-valve magneto-resistive element, magnetic head and magnetic storage apparatus, in which the problem described above is eliminated.

Another and more specific object of the present invention is to provide a spin-valve magneto-resistive element, magnetic head and magnetic storage apparatus, which can suppress effects of an exchange coupling field generated from a pinned magnetic layer with respect to a free magnetic layer, improve a head output, improve symmetry of a reproduced signal waveform of the magnetic head, and improve sensitivity of the spin-valve magneto-resistive element and the magnetic head.

Still another object of the present invention is to provide a spin-valve magneto-resistive element comprising a free magnetic layer having a first surface and a second surface opposite to the first surface, a first stacked structure including a first nonmagnetic metal layer, a first pinned magnetic layer and a first antiferromagnetic layer which are successively stacked on the first surface of the free magnetic layer, and a second stacked structure including a second nonmagnetic metal layer, a second pinned magnetic layer and a second antiferromagnetic layer which are successively stacked on the second surface of the free magnetic layer, where a direction of an exchange coupled field between the first pinned magnetic layer and the free magnetic layer and a direction of an exchange coupled field between the second pinned magnetic layer and the free magnetic layer are antiparallel. According to the spin-valve magneto-resistive element of the present invention, it is possible to suppress the exchange coupling field substantially acting on the free magnetic layer and make the spin-valve magneto-resistive element highly sensitive, so that when used in a magnetic head, it is possible to improve a head output and improve symmetry of a reproduced signal waveform of the magnetic head.

A further object of the present invention is to provide a spin-valve magneto-resistive element comprising a metal oxide layer, made of a metal oxide including copper, and having a first surface and a second surface opposite to the first surface, a first stacked structure including a first free magnetic layer, a first nonmagnetic metal layer, a first pinned magnetic layer and a first antiferromagnetic layer which are successively stacked above the first surface of the metal oxide layer, and a second stacked structure including a second free magnetic layer, a second nonmagnetic metal layer, a second pinned magnetic layer and a second antiferromagnetic layer which are successively stacked under the second surface of the metal oxide layer, where a direction of an exchange coupled field between the first pinned magnetic layer and the first free magnetic layer and a direction of an exchange coupled field between the second pinned magnetic layer and the second free magnetic layer are antiparallel. According to the spin-valve magneto-resistive element of the present invention, it is possible to suppress the exchange coupling field substantially acting on the first and second free magnetic layers as a whole and make the spin-valve magneto-resistive element highly sensitive, so that when used in a magnetic head, it is possible to improve a head output and improve symmetry of a reproduced signal waveform of the magnetic head.

Another object of the present invention is to provide a magnetic head comprising a substrate, and a spin-valve magneto-resistive element disposed above the substrate, where the spin-valve magneto-resistive element comprises a free magnetic layer having a first surface and a second surface opposite to the first surface, a first stacked structure including a first nonmagnetic metal layer, a first pinned magnetic layer and a first antiferromagnetic layer which are successively stacked on the first surface of the free magnetic layer, and a second stacked structure including a second nonmagnetic metal layer, a second pinned magnetic layer and a second antiferromagnetic layer which are successively stacked on the second surface of the free magnetic layer, and a direction of an exchange coupled field between the first pinned magnetic layer and the free magnetic layer and a direction of an exchange coupled field between the second pinned magnetic layer and the free magnetic layer are antiparallel. According to the magnetic head of the present invention, it is possible to improve a head output and improve symmetry of a reproduced signal waveform of the magnetic head by the improved sensitivity of the spin-valve magneto-resistive element.

Still another object of the present invention is to provide a magnetic head comprising a substrate, and a spin-valve magneto-resistive element disposed above the substrate, wherein the spin-valve magneto-resistive element comprises a metal oxide layer, made of a metal oxide including copper, and having a first surface and a second surface opposite to the first surface, a first stacked structure including a first free magnetic layer, a first nonmagnetic metal layer, a first pinned magnetic layer and a first antiferromagnetic layer which are successively stacked above the first surface of the metal oxide layer, and a second stacked structure including a second free magnetic layer, a second nonmagnetic metal layer, a second pinned magnetic layer and a second antiferromagnetic layer which are successively stacked under the second surface of the metal oxide layer, and a direction of an exchange coupled field between the first pinned magnetic layer and the first free magnetic layer and a direction of an exchange coupled field between the second pinned magnetic layer and the second free magnetic layer are antiparallel. According to the magnetic head of the present invention, it is possible to improve a head output and improve symmetry of a reproduced signal waveform of the magnetic head by the improved sensitivity of the spin-valve magneto-resistive element.

A further object of the present invention is to provide a magnetic storage apparatus comprising at least one magnetic recording medium, and at least one magnetic head including a spin-valve magneto-resistive element, where the spin-valve magneto-resistive element comprises a free magnetic layer having a first surface and a second surface opposite to the first surface, a first stacked structure including a first nonmagnetic metal layer, a first pinned magnetic layer and a first antiferromagnetic layer which are successively stacked on the first surface of the free magnetic layer, and a second stacked structure including a second nonmagnetic metal layer, a second pinned magnetic layer and a second antiferromagnetic layer which are successively stacked on the second surface of the free magnetic layer, and a direction of an exchange coupled field between the first pinned magnetic layer and the free magnetic layer and a direction of an exchange coupled field between the second pinned magnetic layer and the free magnetic layer are antiparallel. According to the magnetic storage apparatus of the present invention, it is possible to improve a head output and improve symmetry of a reproduced signal waveform of the magnetic head by the improved sensitivity of the spin-valve magneto-resistive element.

Another object of the present invention is to provide a magnetic storage apparatus comprising at least one magnetic recording medium, and at least one magnetic head including a spin-valve magneto-resistive element, where the spin-valve magneto-resistive element comprises a metal oxide layer, made of a metal oxide including copper, and having a first surface and a second surface opposite to the first surface, a first stacked structure including a first free magnetic layer, a first nonmagnetic metal layer, a first pinned magnetic layer and a first antiferromagnetic layer which are successively stacked above the first surface of the metal oxide layer, and a second stacked structure including a second free magnetic layer, a second nonmagnetic metal layer, a second pinned magnetic layer and a second antiferromagnetic layer which are successively stacked under the second surface of the metal oxide layer, and a direction of an exchange coupled field between the first pinned magnetic layer and the first free magnetic layer and a direction of an exchange coupled field between the second pinned magnetic layer and the second free magnetic layer are antiparallel. According to the magnetic storage apparatus of the present invention, it is possible to improve a head output and improve symmetry of a reproduced signal waveform of the magnetic head by the improved sensitivity of the spin-valve magneto-resistive element.

Other objects and further features of the present invention will be apparent from the following detailed description when read in conjunction with the accompanying drawings.

### BRIEF DESCRIPTION OF THE DRAWINGS

FIG. 1 is a cross sectional view showing a conventional dual type SVMR element;

FIG. 2 is a cross sectional view showing a dual type SVMR element which is formed by use of multi-layered ferrimagnetic type pinned magnetic layers;

FIG. 3 is a diagram for explaining effects of an exchange coupling field between a pinned magnetic layer and a free magnetic layer, with respect to an SVMR element;

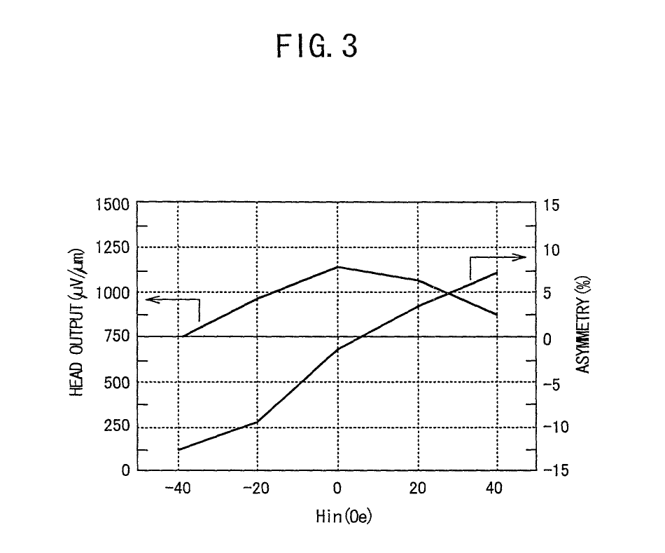

FIG. 4 is a cross sectional view showing a first embodiment of a spin-valve magneto-resistive element according to the present invention;

FIG. 5 is a cross sectional view showing a second embodiment of the spin-valve magneto-resistive element according to the present invention;

FIG. 6 is a cross sectional view showing a third embodiment of the spin-valve magneto-resistive element according to the present invention;

FIG. 7 is a cross sectional view showing an embodiment of a magnetic head according to the present invention; and

FIG. 8 is a plan view showing an embodiment of a magnetic storage apparatus.

### DESCRIPTION OF THE PREFERRED EMBODIMENTS

In the present invention, a dual type spin-valve magneto-resistive (SVMR) element is constructed so that fields generated between a free magnetic layer and first and second pinned magnetic layers disposed on respective sides of the free magnetic layer via a nonmagnetic layer include an exchange coupling field which is based on a ferromagnetic coupling and an exchange coupling field which is based on antiferromagnetic coupling. In other words, it is possible to substantially cancel the fields by making magnetization directions of the two exchange coupling fields acting from the first and second pinned magnetic layers to the free magnetic layer mutually opposite to each other, that is, antiparallel. Accordingly, the field which actually acts on the free magnetic layer substantially becomes a difference between the two exchange coupling fields. This difference can be controlled to become approximately zero, so as to substantially eliminate the field acting on the free magnetic layer. As a result, it is possible to improve a head output of a magnetic head using the dual type SVMR element, improve symmetry of a reproduced signal waveform of the magnetic head, and improve sensitivity of the magnetic head.

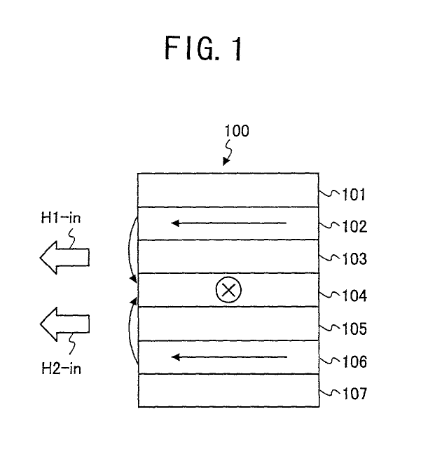

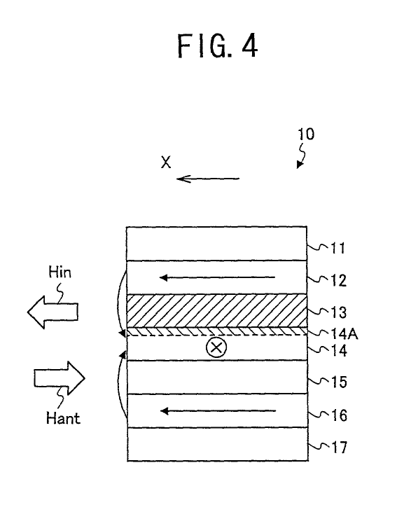

FIG. 4 is a cross sectional view showing a first embodiment of a SVMR element according to the present invention. The basic layer structure of a dual type SVMR element 10 shown in FIG. 4 is similar to that of the conventional dual type SVMR element 100 shown in FIG. 1.

The dual type SVMR element 10 has a free magnetic layer 14, a first stacked structure provided above the free magnetic layer 14, and a second stacked structure provided under the free magnetic layer 14. The first stacked structure includes a first nonmagnetic metal layer 13, a first pinned magnetic layer 12, and a first antiferromagnetic layer 11 which are sequentially stacked above the free magnetic layer 14 in an upward direction. The second stacked structure includes a second nonmagnetic metal layer 15, a second pinned magnetic layer 16, and a second antiferromagnetic layer 17 which are sequentially stacked under the free magnetic layer 14 in a downward direction. The first and second stacked structures respectively form a spin-valve layer structure.

Furthermore, the dual type SVMR element 10 is constructed so that an exchange coupling field Hant from the second pinned magnetic layer 16 to the free magnetic layer 14 is generated in an antiferromagnetic coupling state so as to be antiparallel to a magnetization direction X of the second pinned magnetic layer 16. The structure for generating such an antiferromagnetic coupling state will be described later.

On the other hand, an exchange coupling field Hin from the first pinned magnetic layer 12 to the free magnetic layer 14 is generated in a ferromagnetic coupling state so as to be parallel to the magnetization direction X of the first pinned magnetic layer 12, similarly as in the conventional dual type SVMR element. Accordingly, an exchange coupling field which substantially acts on the free magnetic layer 14 becomes a difference which remains after the exchange coupling layer Hant and the exchange coupling layer Hin act in mutually cancelling directions. It may easily be understood that the resulting exchange coupling field actin on the free magnetic layer 14 is considerably reduced compared to that of the conventional dual type SVMR element. If the exchange coupling field Hin and the exchange coupling field Hant are approximately the same, it is possible to make the resulting exchange coupling field acting on the free magnetic layer 14 approximately zero.

Conventionally, it was difficult to control the exchange coupling field generated between the free magnetic layer and the pinned magnetic layer to within the range of −15 Oe to 15 Oe. However, in the case of the dual type SVMR element 10 of this embodiment, the field acting on the free magnetic layer 14 can be positively controlled to within the range of −15 Oe to 15 Oe because the two exchange coupling fields Hin and Hant act in mutually cancelling directions, and the field acting on the free magnetic layer 14 can be made approximately zero if the two exchange coupling fields Hin and Hant are approximately the same. Therefore, when a magnetic head is formed by the dual type SVMR element 10, it is possible to improve the head output, and also improve the symmetry of the reproduced signal waveform.

Next, a description will be given of the structure of each of the layers forming the dual type SVMR element 10 shown in FIG. 4. Because the dual type SVMR element 10 has an approximately symmetrical structure above and under the free magnetic layer 14, the upper and lower structures will be described together in the following description.

The first and second antiferromagnetic layers 11 and 17 are made of an antiferromagnetic material such as an PdPtMn alloy having a thickness of approximately 150 Å. The first antiferromagnetic layer 11 supplies an exchange bias field for pinning the magnetization direction of the first pinned magnetic layer 16 in a predetermined direction, that is, the magnetization direction X shown in FIG. 4. Similarly, the second antiferromagnetic layer 17 supplies an exchange bias field for pinning the magnetization direction of the second pinned magnetic layer 16 in the magnetization direction X.

The first and second pinned magnetic layers 12 and 16 are made of a magnetic material such as an CoFeB alloy having a thickness of approximately 25 to 50 Å. The first pinned magnetic layer 12 generates an exchange coupling field with respect to the free magnetic layer 14 via the first nonmagnetic metal layer 13. Similarly, the second pinned magnetic layer 16 generates an exchange coupling field with respect to the free magnetic layer 14 via the second nonmagnetic metal layer 15.

As described above, the field from the first pinned magnetic layer 12 to the free magnetic layer 14 is the ferromagnetically coupled exchange coupling field Hin, similarly to the conventional dual type SVMR element, but the field from the second pinned magnetic layer 16 to the free magnetic layer 14 is the antiferromagnetically coupled exchange coupling field Hant unlike the conventional dual type SVMR element.

The first and second nonmagnetic metal layers 13 and 15 are made of a nonmagnetic metal material such as Cu having a thickness of approximately 20 to 30 Å. In this embodiment, the first nonmagnetic metal layer 13 is made of a copper oxide material. The first and second nonmagnetic metal layers 13 and 15 form spacers within the respective spin-valve layer structures and induce giant magneto-resistive (GMR) effects.

The first nonmagnetic metal layer 13 controls the magnetization direction so that the field from the second pinned magnetic layer 16 to the free magnetic layer 14 becomes an antiferromagnetic coupling, unlike the conventional dual type SVMR element. For example, the first nonmagnetic metal layer 13 can realize the above described control of the magnetization direction by forming a copper oxide layer made of Cu₁₋ₓOₓ to a thickness in a range of approximately 12 to 18 Å and preferably approximately 15 Å, where 0<x<1. Furthermore, when the second nonmagnetic metal layer 15 is made of a Cu layer which is formed to a thickness in a range of approximately 22 to 30 Å, it is possible to more positively obtain the antiferromagnetically coupled exchange coupling field by inverting the magnetization direction of the ferromagnetically coupled exchange coupling field acting from the second pinned magnetic layer 16 to the free magnetic layer 14.

Although not essential, it is possible to provide an oxide layer 14A between the first nonmagnetic metal layer 13 and the free magnetic layer 14 as shown in FIG. 4. The oxide layer 14A may be formed by oxidizing the upper surface of the free magnetic layer 14 in FIG. 4. By providing this oxide layer 14A, it is also possible to similarly obtain the antiferromagnetically coupled exchange coupling field by inverting the magnetization direction of the ferromagnetically coupled exchange coupling field acting from the second pinned magnetic layer 16 to the free magnetic layer 14.

The free magnetic layer 14 is made of a magnetic material such as an CoFeB alloy having a thickness of approximately 15 Å. Because the first and second nonmagnetic metal layers 13 and 15 described above are provided, the fields supplied to the free magnetic layer 14 becomes the difference between the ferromagnetically coupled exchange coupling field Hin from the first pinned magnetic layer 12 and the antiferromagnetically coupled exchange coupling field Hant from the second pinned magnetic layer 16. Hence, it is possible to effectively suppress the exchange coupling field acting on the free magnetic layer 14 compared not only to the conventional dual type SVMR element but even compared to the conventional single type SVMR element.

Generally, the exchange coupling field between the free magnetic layer and the pinned magnetic layer is set as close as possible to the range of −15 Oe to 15 Oe, as described above. But in this embodiment, the mutual cancellation of the fields occur, because the magnetization direction of the exchange coupling field from the first pinned magnetic layer 12 and the magnetization direction of the exchange coupling field from the second pinned magnetic layer 16 become opposite to each other. Accordingly, the resulting exchange coupling field in this embodiment falls within the range of −15 Oe to 15 Oe, and if the exchange coupling field from the first pinned magnetic layer 12 and the exchange coupling field from the second pinned magnetic layer 16 are approximately the same, it is possible to make the resulting field acting on the free magnetic layer 14 approximately zero.

In this embodiment, the exchange coupling field between the second pinned magnetic layer 16 and the free magnetic layer 14 is made to become antiferromagnetically coupled, but it is of course possible to control the exchange coupling field between the first pinned magnetic layer 12 and the free magnetic layer 14 to become antiferromagnetically coupled.

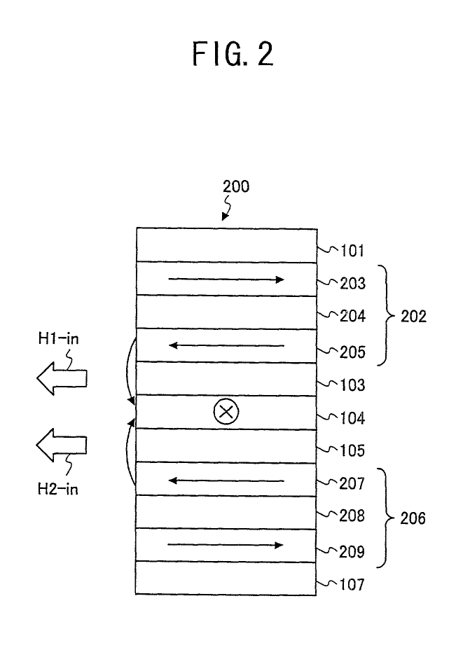

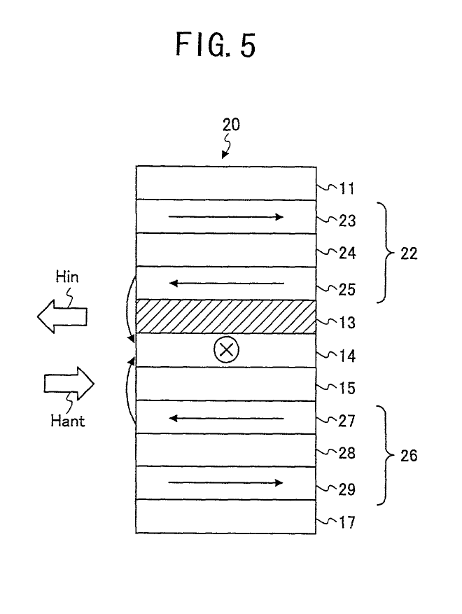

FIG. 5 is a cross sectional view showing a second embodiment of the SVMR element according to the present invention. In FIG. 5, those parts which are the same as those corresponding parts in FIG. 4 are designated by the same reference numerals, and a description thereof will be omitted. The basic layer structure of a dual type SVMR element 20 shown in FIG. 5 is similar to that of the conventional dual type SVMR element 200 shown in FIG. 2. In this second embodiment, first and second pinned magnetic layers 22 and 26 respectively have a multi-layered ferrimagnetic structure.

The multi-layered ferrimagnetic structure of the first pinned magnetic layer 22 is formed by a lower magnetic layer 25, an antiparallel coupling layer 24 made of Ru or the like, and an upper magnetic layer 23. The upper and lower magnetic layers 23 and 25 are antiferromagnetically coupled via the antiparallel coupling layer 24. Similarly, the multi-layered ferrimagnetic structure of the second pinned magnetic layer 26 is formed by an upper magnetic layer 27, an antiparallel coupling layer 28 made of Ru or the like, and a lower magnetic layer 29. The upper and lower magnetic layers 27 and 29 are antiferromagnetically coupled via the antiparallel coupling layer 28.

Compared to the pinned magnetic layer having a single-layer structure as in the case of the dual type SVMR element 10 shown in FIG. 4, the exchange coupling field generated by the pinned magnetic layer shown in FIG. 5 having the multi-layered ferrimagnetic structure with respect to the free magnetic layer is reduced.

In FIG. 5, the first and second pinned magnetic layers 22 and 26 having the multi-layered ferrimagnetic structure respectively correspond to the first and second pinned magnetic layers 12 and 16 shown in FIG. 4.

In the first pinned magnetic layer 22, the upper and lower magnetic layers 23 and 25 are made of a CoFeB alloy, for example, and the upper magnetic layer 23 has a thickness of approximately 25 Å, and the lower magnetic layer 25 has a thickness of approximately 15 Å. The antiparallel coupling layer 24 couples the magnetization directions of the upper and lower magnetic layers 23 and 25 in an antiparallel state. For example, the antiparallel coupling layer 24 is made of Ru, and has a thickness of approximately 7.5 Å.

The upper and lower magnetic layers 27 and 29 and the antiparallel coupling layer 28 of the second pinned magnetic layer 26 have compositions similar to the corresponding layers of the first pinned magnetic layer 22. The antiparallel coupling layer 28 couples the magnetization directions of the upper and lower magnetic layers 27 and 29 in an antiparallel state.

Similarly to the structure shown in FIG. 4, the structure shown in FIG. 5 has the first nonmagnetic metal layer 13 disposed directly on the free magnetic layer 14 or, disposed on the free magnetic layer 14 via an oxide layer (not shown). The oxide layer may be formed by oxidizing the surface of the free magnetic layer 14. For example, the nonmagnetic metal layer 13 is made of copper oxide which is formed to a predetermined thickness to also function as a spacer. On the other hand, the second nonmagnetic metal layer 15 is disposed on the opposite side of the free magnetic layer 13. For example, the second nonmagnetic metal layer 15 is made of Cu which is formed to a predetermined thickness.

In the dual type SVMR element 20, the field which substantially acts on the free magnetic layer 14 is the difference between the exchange coupling field Hant from the lower magnetic layer 25 of the first pinned magnetic layer 22 and the exchange coupling field Hin from the upper magnetic layer 27 of the second pinned magnetic layer 26 which act in mutually cancelling directions. For this reason, the resulting field which acts on the free magnetic layer 14 is further reduced when compared to the conventional dual type SVMR element 200 shown in FIG. 2 employing the multi-layered ferrimagnetic structure.

In this second embodiment, the first pinned magnetic layer 22 disposed above the free magnetic layer 14 and the second pinned magnetic layer 26 disposed under the free magnetic layer 14 both have the multi-layered ferrimagnetic structure. However, similar effects are obtainable even when the multi-layered ferrimagnetic structure is employed for only one of the first and second pinned magnetic layers 22 and 26.

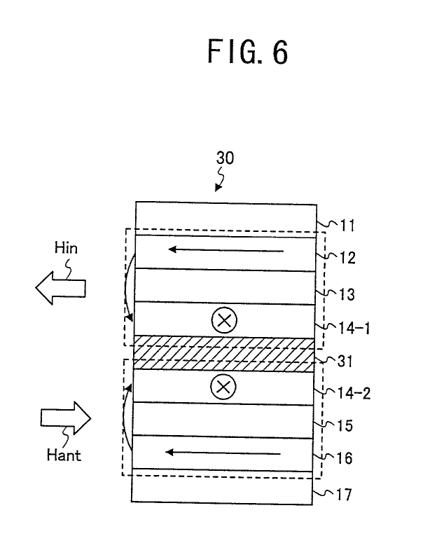

FIG. 6 is a cross sectional view showing a third embodiment of the SVMR element according to the present invention. In FIG. 6, those parts which are the same as those corresponding parts in FIG. 4 are designated by the same reference numerals, and a description thereof will be omitted.

A dual type SVMR element 30 shown in FIG. 6 has an approximately symmetrical structure above and under a copper oxide layer 31. Unlike the dual type SVMR element 10 shown in FIG. 4, the dual type SVMR element 30 has a first free magnetic layer 14-1 and a second free magnetic layer 14-2 which sandwich the copper oxide layer 31. In addition, although the first nonmagnetic metal layer 13 of the first embodiment is formed by the copper oxide material, the first nonmagnetic metal layer 13 of this third embodiment is made of Cu for functioning as a spacer of a general spin-valve layer structure.

In FIG. 6, the first nonmagnetic metal layer 13 of the first, upper stacked structure is made of Cu having a thickness of approximately 20 Å. On the other hand, the second nonmagnetic metal layer 15 of the second, lower stacked structure is made of Cu having a thickness of approximately 20 to 30 Å. In addition, the copper oxide layer 31 has a thickness in a range of approximately 12 to 18 Å, and desirably approximately 15 Å. According to this structure, an antiferromagnetically coupled exchange coupling field acts on the second free magnetic layer 14-2 from the second pinned magnetic layer 16, and a ferromagnetically coupled exchange coupling field acts on the first free magnetic layer 14-1 from the first pinned magnetic layer 12. Moreover, since the copper oxide layer 31 between the first and second free magnetic layers 14-1 and 14-2 is approximately 15 Å and thin, it is possible to generate exchange coupling fields assuming a parallel state between the first and second free magnetic layers 14-1 and 14-2.

Therefore, according to this third embodiment, the ferromagnetically coupled exchange coupling field is supplied from the first pinned magnetic layer 12 to the first free magnetic layer 14-1, and the antiferromagnetically coupled exchange coupling field is supplied from the second pinned magnetic layer 12 to the second free magnetic layer 14-2. In addition, the generated exchange coupling fields assume a parallel state between the first and second free magnetic layers 14-1 and 14-2.

When the first and second free magnetic layers 14-1 and 14-2 are regarded as a single free magnetic layer 14, the field acting with respect to the free magnetic layer 14 becomes the difference between the exchange coupling field Hin from the first pinned magnetic layer 12 and the exchange coupling field Hant from the second pinned magnetic layer 16 which act in mutually cancelling directions. Thus, the resulting exchange coupled field which acts on the free magnetic layer 14 (first and second free magnetic layers 14-1 and 14-2) is sufficiently reduced compared to the exchange coupling field acting in the conventional dual type SVMR element 100 shown in FIG. 1. Therefore, when a magnetic head is formed by the dual type SVMR element 30, it is possible to improve the head output, and also improve the symmetry of the reproduced signal waveform.

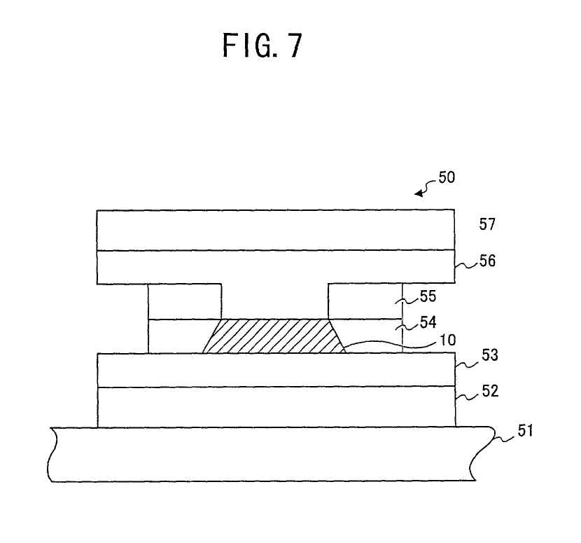

Next, a description will be given of an embodiment of a magnetic head according to the present invention, by referring to FIG. 7. FIG. 7 is a cross sectional view showing this embodiment of the magnetic head according to the present invention.

A magnetic head 50 shown in FIG. 7 uses any one of the dual type SVMR elements 10, 20 and 30 of the first, second and third embodiments shown in FIGS. 4, 5 and 6. For the sake of convenience, it is assumed in the following description that the magnetic head 50 uses the dual type SVMR element 10 of the first embodiment shown in FIG. 4.

The magnetic head 50 shown in FIG. 7 includes a nonmagnetic substrate 51, a lower shield layer 52 disposed on the nonmagnetic substrate 51, a lower insulator layer 53 disposed on the lower shield layer 52, the dual type SVMR element 10 formed on the lower insulator layer 53, a pair of magnetic domain control layers 54 disposed on the right and left of the dual type SVMR element 10, a pair of electrodes 55 disposed on the pair of magnetic domain control layers 54, an upper insulator layer 56 disposed on the pair of electrodes 55 and the dual type SVMR element 10, and an upper shield layer 57 disposed on the upper insulator layer 56. In a case where the magnetic head 50 functions not only as a reproducing head but also as a recording head, a recording head part (not shown) is disposed on the upper shield layer 57.

The magnetic head 50 including the dual type SVMR element 10 may be formed by conventional thin film deposition techniques, such as sputtering, to successively form the constituent layers.

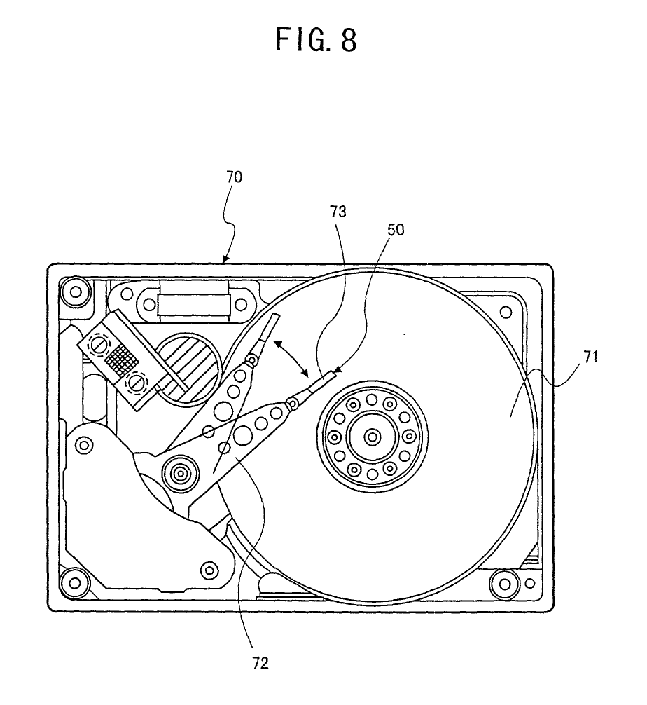

Next, a description will be given of an embodiment of a magnetic storage apparatus according to the present invention, by referring to FIG. 8. FIG. 8 is a plan view showing this embodiment of the magnetic storage apparatus according to the present invention.

The magnetic storage apparatus includes at least one magnetic disk (hard disk) 71 which is rotatably supported, at least one arm 72 which is pivotally supported, a slider 73 provided on a tip end of the arm 72, and the magnetic head 50 provided on the slider 73. For the sake of convenience, it is assumed that the magnetic head 50 uses the dual type SVMR element 10. The magnetic head 50 floats from the surface of the rotating hard disk 71, and reproduces information from the hard disk 71 by the dual type SVMR element 10 during a reproducing operation, and records information on the hard disk 71 by the recording head part of the magnetic head 50 in a case where the recording head part is provided.

The basic structure of the magnetic storage apparatus 70 is not limited to that shown in FIG. 8, and may employ any known basic structures. In addition, a magnetic recording medium used by the magnetic storage apparatus is not limited to the hard disk, and the magnetic recording medium may take any form such as a magnetic card. Moreover, the positioning of the magnetic head 50 may be carried out by any known means, including a two-stage actuator made up of a normal actuator and an electromagnetic fine-adjustment actuator.

Further, the present invention is not limited to these embodiment, but various variations and modifications may be made without departing from the scope of the present invention.

What is claimed is

1. A spin-valve magneto-resistive element comprising:
a free magnetic layer having a first surface and a second surface opposite to the first surface;
a first stacked structure including a first nonmagnetic metal layer, a first pinned magnetic layer and a first antiferromagnetic layer which are successively stacked on the first surface of the free magnetic layer; and
a second stacked structure including a second nonmagnetic metal layer, a second pinned magnetic layer and a second antiferromagnetic layer which are successively stacked on the second surface of the free magnetic layer,
a direction of an exchange coupled field between the first pinned magnetic layer and the free magnetic layer and a direction of an exchange coupled field between the second pinned magnetic layer and the free magnetic layer being antiparallel.

2. The spin-valve magneto-resistive element as claimed in claim 1, wherein at least one of the first and second pinned magnetic layers having a multi-layered ferrimagnetic structure.

3. The spin-valve magneto-resistive element as claimed in claim 1, wherein the first nonmagnetic metal layer is made of a metal oxide including copper.

4. The spin-valve magneto-resistive element as claimed in claim 3, further comprising:
a metal oxide layer formed on the first surface of the free magnetic layer by oxidizing the free magnetic layer,
said metal oxide forming the first nonmagnetic metal layer being formed on the metal oxide layer.

5. The spin-valve magneto-resistive element as claimed in claim 3, wherein a field supplied to the free magnetic layer corresponds to a difference between an exchange coupling field which is based on a ferromagnetic coupling between the first pinned magnetic layer and the free magnetic layer via the first nonmagnetic metal layer and an exchange coupling field which is based on an antiferromagnetic coupling between the second pinned magnetic layer and the free magnetic layer via the second nonmagnetic metal layer, said difference being in a range of approximately −15 Oe to 15 Oe.

6. A spin-valve magneto-resistive element comprising:
a metal oxide layer, made of a metal oxide including copper, and having a first surface and a second surface opposite to the first surface;
a first stacked structure including a first free magnetic layer, a first nonmagnetic metal layer, a first pinned magnetic layer and a first antiferromagnetic layer which are successively stacked above the first surface of the metal oxide layer; and
a second stacked structure including a second free magnetic layer, a second nonmagnetic metal layer, a second pinned magnetic layer and a second antiferromagnetic layer which are successively stacked under the second surface of the metal oxide layer,
a direction of an exchange coupled field between the first pinned magnetic layer and the first free magnetic layer and a direction of an exchange coupled field between the second pinned magnetic layer and the second free magnetic layer being antiparallel.

7. The spin-valve magneto-resistive element as claimed in claim 6, further comprising:
an oxide layer formed on at least one of the first and second free magnetic layers contacting the metal oxide layer by oxidizing the at least one of the first and second free magnetic layers.

8. The spin-valve magneto-resistive element as claimed in claim 7, wherein a difference between an exchange coupling field which is based on a ferromagnetic coupling between the first pinned magnetic layer and the first free magnetic layer via the first nonmagnetic metal layer and an exchange coupling field which is based on an antiferromagnetic coupling between the second pinned magnetic layer and the second free magnetic layer via the second nonmagnetic metal layer is in a range of approximately −15 Oe to 15 Oe.

9. A magnetic head comprising:
a substrate; and
a spin-valve magneto-resistive element disposed above the substrate,
said spin-valve magneto-resistive element comprising:
a free magnetic layer having a first surface and a second surface opposite to the first surface;
a first stacked structure including a first nonmagnetic metal layer, a first pinned magnetic layer and a first antiferromagnetic layer which are successively stacked on the first surface of the free magnetic layer; and
a second stacked structure including a second nonmagnetic metal layer, a second pinned magnetic layer and a second antiferromagnetic layer which are successively stacked on the second surface of the free magnetic layer,
a direction of an exchange coupled field between the first pinned magnetic layer and the free magnetic layer and a direction of an exchange coupled field between the second pinned magnetic layer and the free magnetic layer being antiparallel.

10. A magnetic head comprising:
a substrate; and
a spin-valve magneto-resistive element disposed above the substrate,
said spin-valve magneto-resistive element comprising:
a metal oxide layer, made of a metal oxide including copper, and having a first surface and a second surface opposite to the first surface;
a first stacked structure including a first free magnetic layer, a first nonmagnetic metal layer, a first pinned magnetic layer and a first antiferromagnetic layer which are successively stacked above the first surface of the metal oxide layer; and
a second stacked structure including a second free magnetic layer, a second nonmagnetic metal layer, a second pinned magnetic layer and a second antiferromagnetic layer which are successively stacked under the second surface of the metal oxide layer,
a direction of an exchange coupled field between the first pinned magnetic layer and the first free magnetic layer and a direction of an exchange coupled field between the second pinned magnetic layer and the second free magnetic layer being antiparallel.

11. A magnetic storage apparatus comprising:
at least one magnetic recording medium; and
at least one magnetic head including a spin-valve magneto-resistive element,
said spin-valve magneto-resistive element comprising:
a free magnetic layer having a first surface and a second surface opposite to the first surface;
a first stacked structure including a first nonmagnetic metal layer, a first pinned magnetic layer and a first antiferromagnetic layer which are successively stacked on the first surface of the free magnetic layer; and
a second stacked structure including a second nonmagnetic metal layer, a second pinned magnetic layer and a second antiferromagnetic layer which are successively stacked on the second surface of the free magnetic layer,
a direction of an exchange coupled field between the first pinned magnetic layer and the free magnetic layer and a direction of an exchange coupled field between the second pinned magnetic layer and the free magnetic layer being antiparallel.

12. A magnetic storage apparatus comprising:
at least one magnetic recording medium; and
at least one magnetic head including a spin-valve magneto-resistive element,
said spin-valve magneto-resistive element comprising:
a metal oxide layer, made of a metal oxide including copper, and having a first surface and a second surface opposite to the first surface;
a first stacked structure including a first free magnetic layer, a first nonmagnetic metal layer, a first pinned magnetic layer and a first antiferromagnetic layer which are successively stacked above the first surface of the metal oxide layer; and
a second stacked structure including a second free magnetic layer, a second nonmagnetic metal layer, a second pinned magnetic layer and a second antiferromagnetic layer which are successively stacked under the second surface of the metal oxide layer,
a direction of an exchange coupled field between the first pinned magnetic layer and the first free magnetic layer and a direction of an exchange coupled field between the second pinned magnetic layer and the second free magnetic layer being antiparallel.
